(19) United States
(12) Patent Application Publication
(10) Pub. No.: US 2026/0127763 A1
(43) Pub. Date: May 7, 2026

(54) CALIBRATION OF PARAMETERS OF A SENSOR

(71) Applicant: QUALCOMM Incorporated, San Diego, CA (US)

(72) Inventors: Bjoern JOHANSSON, Linköping (SE); Hagen SPIES, Stockholm (SE)

(21) Appl. No.: 18/940,185

(22) Filed: Nov. 7, 2024

(51) Int. Cl. G06T 7/80

(52) U.S. Cl. CPC G06T 7/80; G06T 2207/30252

(57) ABSTRACT

Systems and techniques are described herein for image processing. For example, a computing device can determine, from a first image and a second image received from or by a sensor, a first plurality of two-dimensional points, wherein the first plurality of two-dimensional points are represented in the first image and correspond to two-dimensional points represented in the second image; apply a non-linear lens distortion function associated with the sensor to the first plurality of two-dimensional points to adjust the first plurality of two-dimensional points; determine a plurality of epipolar constraints based on the adjusted first plurality of two-dimensional points; estimate at least one intrinsic parameter of the sensor based on the plurality of epipolar constraints; and process an additional image received from the sensor using the at least one estimated intrinsic parameter of the sensor.

### FIELD

The present disclosure generally relates to calibration techniques for sensors. For example, aspects of the present disclosure relate to systems and techniques for calibration of parameters of a sensor.

### BACKGROUND

Sensors are generally designed with an understanding of the accuracy and capabilities of the sensor based on the hardware components used in the sensors. The capabilities of sensors can change over time as hardware of the sensor degrades. Many systems and devices (e.g., autonomous vehicles, such as autonomous and semi-autonomous cars, drones, mobile robots, mobile devices, extended reality (XR) devices, and other suitable systems or devices) include multiple sensors to gather information about the environment. The accuracy of sensor data is important for systems and devices in motion, such as autonomous vehicles, because inaccurate sensor data resulting from hardware degradation can have unintended consequences, such as causing a collision. Calibration of sensors is important to ensure accuracy of sensor data as the capabilities and accuracy of a sensor deviate over time.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for image processing is provided. The apparatus can include at least one memory and at least one processor coupled to the at least one memory. The processor can be configured to determine, from a first image and a second image received from a sensor, a first plurality of two-dimensional points, wherein the first plurality of two-dimensional points are represented in the first image and correspond to two-dimensional points represented in the second image; apply a non-linear lens distortion function associated with the sensor to the first plurality of two-dimensional points to adjust the first plurality of two-dimensional points; determine a plurality of epipolar constraints based on the adjusted first plurality of two-dimensional points; estimate at least one intrinsic parameter of the sensor based on the plurality of epipolar constraints; and process an additional image received from the sensor using the at least one estimated intrinsic parameter of the sensor.

In some aspects, a method for image processing is provided. The method can include: determining, from a first image and a second image received from a sensor, a first plurality of two-dimensional points, wherein the first plurality of two-dimensional points are represented in the first image and correspond to two-dimensional points represented in the second image; applying a non-linear lens distortion function associated with the sensor to the first plurality of two-dimensional points to adjust the first plurality of two-dimensional points; determining a plurality of epipolar constraints based on the adjusted first plurality of two-dimensional points; estimating at least one intrinsic parameter of the sensor based on the plurality of epipolar constraints; and processing an additional image received from the sensor using the at least one estimated intrinsic parameter of the sensor.

In some aspects, a non-transitory computer-readable medium is provided having stored thereon instructions that, when executed by at least one processor, cause the at least one processor to: determine, from a first image and a second image received from a sensor, a first plurality of two-dimensional points, wherein the first plurality of two-dimensional points are represented in the first image and correspond to two-dimensional points represented in the second image; apply a non-linear lens distortion function associated with the sensor to the first plurality of two-dimensional points to adjust the first plurality of two-dimensional points; determine a plurality of epipolar constraints based on the adjusted first plurality of two-dimensional points; estimate at least one intrinsic parameter of the sensor based on the plurality of epipolar constraints; and process an additional image received from the sensor using the at least one estimated intrinsic parameter of the sensor.

In some aspects, an apparatus for image processing is provided. The apparatus includes: means for determining, from a first image and a second image received from a sensor, a first plurality of two-dimensional points, wherein the first plurality of two-dimensional points are represented in the first image and correspond to two-dimensional points represented in the second image; means for applying a non-linear lens distortion function associated with the sensor to the first plurality of two-dimensional points to adjust the first plurality of two-dimensional points; means for determining a plurality of epipolar constraints based on the adjusted first plurality of two-dimensional points; means for estimating at least one intrinsic parameter of the sensor based on the plurality of epipolar constraints; and means for processing an additional image received from the sensor using the at least one estimated intrinsic parameter of the sensor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

FIGS. 1A and 1B are block diagrams illustrating a vehicle suitable for implementing various techniques described herein, in accordance with aspects of the present disclosure.

FIG. 1C is a block diagram illustrating components of a vehicle suitable for implementing various techniques described herein, in accordance with aspects of the present disclosure.

FIG. 1D illustrates an example implementation of a system-on-a-chip (SOC), in accordance with aspects of the present disclosure.

FIG. 2 is a block diagram illustrating an example architecture of an image capture and processing system, in accordance with aspects of the present disclosure.

FIG. 3 is a block diagram illustrating visual odometry (VO) performed across two images, in accordance with aspects of the present disclosure.

FIG. 4 is a diagram illustrating an example of relative pose determination using points of interest from images captured by a camera or received by a device from the camera, in accordance with aspects of the present disclosure.

FIG. 5 is a flow diagram illustrating an example process for determining parameters of an optical sensor using visual odometry, in accordance with aspects of the present disclosure.

FIG. 6 is a flow diagram illustrating an example process for calibrating an optical sensor, in accordance with aspects of the present disclosure.

FIG. 7 is a flow diagram illustrating an example process for calibrating a sensor, in accordance with aspects of the present disclosure.

FIG. 8 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, many systems and devices use sensors to gather information about the environment. For example, vehicles (e.g., autonomous or semi-autonomous vehicles), mobile robots, extended reality (XR) devices (e.g., virtual reality (VR), augmented reality (AR), and/or mixed reality (MR) devices), among other devices, can gather sensor data about the environment and use the sensor data to perform various actions, such as route planning, navigation, collision avoidance, etc. Sensor data accuracy is important for such systems and devices. For example, inaccurate sensor data can result in unintended consequences for systems and devices, such as collisions or failure to accurately perform an action.

Sensors are generally designed with an understanding of the capabilities of the sensors, which can be represented as parameters (e.g., intrinsic parameters and extrinsic parameters) of the sensors. For example, intrinsic parameters generally are software value representations of the hardware. Intrinsic parameters (also referred to as intrinsics) can include parameters such as resolution, light sensitivity, dynamic range, noise characteristics, fill factor, skew, focal length etc. The capabilities of a sensor can change over time as hardware of the sensor degrades. Extrinsic parameters (also referred to as extrinsics) can include the position and orientation of the sensor.

For example, sensors that are part of systems that primarily operate outside may experience many thermal cycles resulting from fluctuations in temperature and weather. Further, ultra-violet (UV) rays from the sun can degrade or warp components of sensors, affecting the capabilities of the sensors. The accuracy of sensor data can be particularly important for systems and devices in motion, such as autonomous vehicles, because inaccurate sensor data resulting from hardware degradation can prevent the systems and devices from performing tasks. Calibration of sensors is important to ensure accuracy of the sensor data as the capabilities of the sensor, represented by intrinsic parameters and extrinsic parameters of the sensor, changes. Further, changes in accuracy of a sensor can cause a system (e.g., an autonomous vehicle) to be out of compliance with laws and regulations for safe operation.

Optical sensors (e.g., cameras) on cars can be especially impacted by long term exposure to fluctuations in temperature and UV rays because optical sensors are generally located on the outside of the car. Further, cars are primarily operated outside, exposed to weather and UV rays. Many optical sensors include lenses that are made of plastic. UV rays can warp the shape of plastic and reduce transparency by causing yellowing or other occlusions. In some cases, intrinsic parameters of optical sensors, such as focal length and principal point have been found to vary as a function of ambient temperature or aging. Intrinsic parameters of optical sensors can vary over shorter time periods as well, such as during operation of the optical sensor. For example, parking cameras are often located (e.g., mounted) outside of the vehicle exposed to direct sunlight that can cause heating of components of the cameras (e.g., image sensors, image signal processor (ISP), etc.) or exposed to outside temperatures in a cold climate that can cause cooling of the components. Further, cameras mounted inside the vehicle on a windshield can be exposed to high temperatures (e.g., sunlight through the windshield heating the cameras, the overall temperature of the inside of the car increasing due to environmental temperature and sunlight, etc.).

Further, the initial intrinsic parameters of sensors can also be suboptimal from an insufficient factory calibration, or when using nominal values from a data sheet or a design software.

Systems, apparatuses, methods (also referred to as processes), and computer-readable media (collectively referred to herein as “systems and techniques”) are described herein that provide calibration techniques for determining parameters (e.g., intrinsic parameters and extrinsic parameters) of optical sensors and updating software or applications associated with the optical sensors based on changes in the parameters. The systems and techniques can determine the parameters during usage of the optical sensor (e.g., when the sensor is online/deployed on a device), in contrast to calibration procedures performed at a preset location, such as within a manufacturing facility, at a service station, etc.

In some aspects, the systems and techniques can use visual odometry of images captured by the optical sensor or received images to determine the intrinsic parameters and the extrinsic parameters of the optical sensor. Visual odometry (VO) is used in robotics and computer vision to denote a process of estimating the motion of the optical sensor from an image sequence. Motion can refer to change in relative pose of the optical sensor during time between the optical sensor capturing the first image and capturing the second image. For example, relative pose refers to the location of the optical sensor and orientation (e.g., rotation) of the optical sensor expressed in a coordinate system. The relative pose can include 6 degrees-of-freedom (6DOF), including translation (in X, Y, and Z directions) and rotation (for example represented as roll, pitch, and yaw). In some examples, the optical sensor is a camera, such as a camera part of a vehicle (e.g., an autonomous or semi-autonomous vehicle) or other system or device. In further examples, the camera can be a fisheye camera, a 360-Degree camera, etc. VO can be estimated using a single camera (e.g., mono) or a multicamera system (e.g., stereo).

In some aspects, the visual odometry includes estimating the trajectory of the optical sensor by analyzing consecutive images taken as the optical sensor moves through an environment. A system performing visual odometry can detect features of a first image and match the features of the first image to features of a second image. The system can determine relative motion of the optical sensor from shifts in matched features from the first image to the second image. For example, the system can identify regions present in a first image. The system can further identify regions in the second image corresponding to the regions present in the first image. Based on the movement of the region from the first image to the second image, the system can calculate motion of the optical sensor in an environment. In some examples, the system can include an inertial measurement unit (IMU) to assist in determining motion of the optical sensor.

In some aspects, the motion of the optical sensor (e.g., relative change in optical sensor pose, also referred to as relative pose) can be represented as a matrix and/or as a vector (e.g., a 3×3 rotation matrix and a 3×1 translation vector). For instance, the 3×3 rotation matrix can be used to represent the orientation of the optical sensor in a three-dimensional space. The translation matrix can be a 3×1 vector used to represent a movement in location of the sensor.

Intrinsic parameters refer to values representing the operation of the sensor, such as the focal length and principal point cx and cy (also called pinhole parameters) of the optical sensor. The optical sensor can perform online or dynamic calibration, meaning the intrinsic parameters and extrinsic parameters of the optical sensor can be determined (e.g., estimated) during normal operation of the optical sensor. In contrast, offline or static calibration refers to a separate calibrating mode different from normal operation of the optical sensor. For example, offline calibration can refer to the use of aids or separate operating modes to calibrate the optical sensor (e.g., using a chessboard pattern image to calibrate the optical sensor).

An epipolar constraint can be used to estimate the relative pose of a sensor across two or more frames (e.g., two or more images). In some examples, the epipolar constraint can be used to analytically compute relative pose. For example, the relative pose can be estimated using random sample consensus (RANSAC) or various iterative robust methods (e.g., least trimmed squares, iteratively reweighted least squares, etc.).

Intrinsic parameters of a sensor define how the sensor interprets and transforms physical measurements into digital data. For an optical sensor, intrinsic parameters can include focal length (e.g., field of view and depth of focus), principal point (e.g., optical center), skew, aspect ratio, among other examples. In some examples, the intrinsic parameters of the optical sensor can be represented as a matrix of values associated with the focal length, principal point, skew, and the aspect ratio. The matrix can include additional elements to set the dimensions of the matrix to an appropriate size for matrix algebra calculations (e.g., populating the matrix with additional 1s or 0s).

In some aspects, a non-linear lens distortion function associated with the optical sensor can be applied to the epipolar constraints. The non-linear lens distortion function represents deviations in the way light passes through the lens (e.g., reflections, refractions, etc.). The deviations can cause distortions in the appearance of objects in images captured by (and in some cases received from) the optical sensor. When the non-linear lens distortion function is known, the intrinsic parameters of the optical sensor become more observable because intrinsic parameters become less correlated to extrinsic parameters (e.g., orientation, position, etc.) of the optical sensor. For example, for two-frame translations, intrinsic are generally not observable in a pinhole camera without distortion. Adding a known non-linearity, such as the non-linear lens distortion function, to the epipolar constraints can allow the intrinsic parameters to be estimated. The intrinsic parameters and extrinsic parameters can be estimated by minimizing a goal function of the epipolar constraints. The relative motion of the optical sensor can additionally be estimated by minimizing the goal function.

In some aspects, the system and techniques can determine a plurality of two-dimensional points. The plurality of two-dimensional points are represented in a first image and correspond to two-dimensional points represented in a second image, and can be referred to as corresponding two-dimensional points. For instance, the systems and techniques can determine the plurality of two-dimensional points that correspond between the first image and the second image. The first image and the second image can be images captured by the optical sensor over a period of time (and in some cases received by a device from the optical sensor). In some examples, the optical sensor is in motion in the period of time between taking the first image and the second image. In further aspects, the systems and techniques can apply a non-linear function, such as a non-linear lens distortion function associated with the optical sensor, to the plurality of two-dimensional points to normalize the plurality of corresponding two-dimensional points.

In some aspects, the systems and techniques determine a plurality of epipolar constraints based on a normalized plurality of two-dimensional points. The epipolar constraints can be used to estimate the intrinsic parameters of the optical sensor and the extrinsic parameters of the optical sensor such as the relative pose of the optical sensor across the first image and the second image. For example, the systems and techniques can define a goal function including a variable representing intrinsic parameters of the optical sensor and a variable representing the relative pose of the optical sensor. The systems and techniques can perform analytical calculations of the goal function to minimize the goal function. In some examples, the systems and techniques can perform non-linear optimization techniques to the goal function such as performing Levenberg-Marquardt algorithms or DogLeg algorithms. The systems and techniques can use the aforementioned algorithms to solve a non-linear least squares equation (e.g., the goal function) with respect to the intrinsic parameters and the relative pose of the optical sensor.

In some examples, the systems and techniques can add a robust weight to the goal function, e.g., Huber or Cauchy, or use RANSAC to account for outliers in the epipolar constraints.

The intrinsic parameters can change much slower than the vehicle motion (e.g., the intrinsics of sensors generally change much slower than the extrinsics). Furthermore, the systems and techniques can benefit from performance of multiple VO algorithms for extrinsics. For example, the systems and techniques can run multiple VO instances in parallel, such as a first VO instance to estimate extrinsics with lower delay and a second instance to estimate intrinsic parameters with slower update rate to increase accuracy of estimated intrinsic parameters. In some examples, the second instance of the VO can be initialized with the motion computed by the first instance of the VO (e.g., determining the intrinsic parameters using already determined relative pose information).

In some examples, not all of the intrinsic parameters need to be updated. For example, not all intrinsic parameters may need to be updated when the optical sensor is online. For example, skew and aspect ratio could be determined to not have changed during operation of the optical sensor. In such an example, the systems and techniques can update the focal length and principal point, or also assume focal length is known from a temperature table, and only update the principal point. In some examples, optimization of the intrinsic parameters of the optical sensor can be initiated using intrinsic values from nominal or factory calibrations, or from last values before upstart.

In some examples, such as when the optical sensor is a camera with rolling shutter, an additional non-linear functions can be added (e.g., additionally applied to the epipolar constraints) to account for distortion from the rolling shutter. In another example, when the camera is inside a cockpit of a vehicle, an additional non-linear function can be added to account for distortion of light through a windshield.

Various aspects of the application will be described with respect to the figures below.

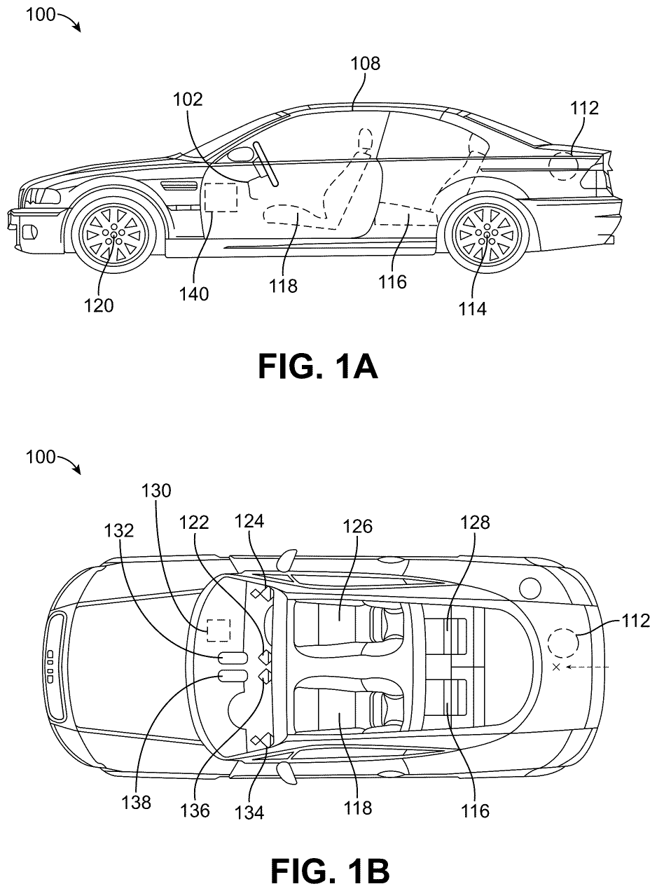

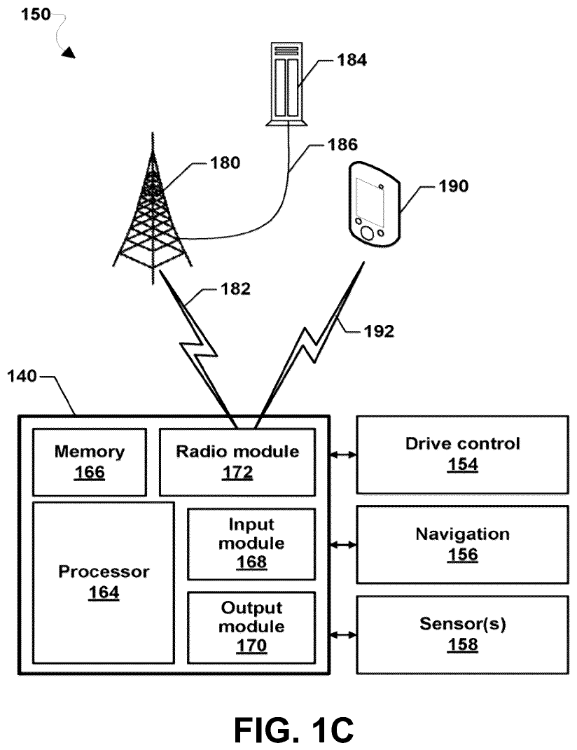

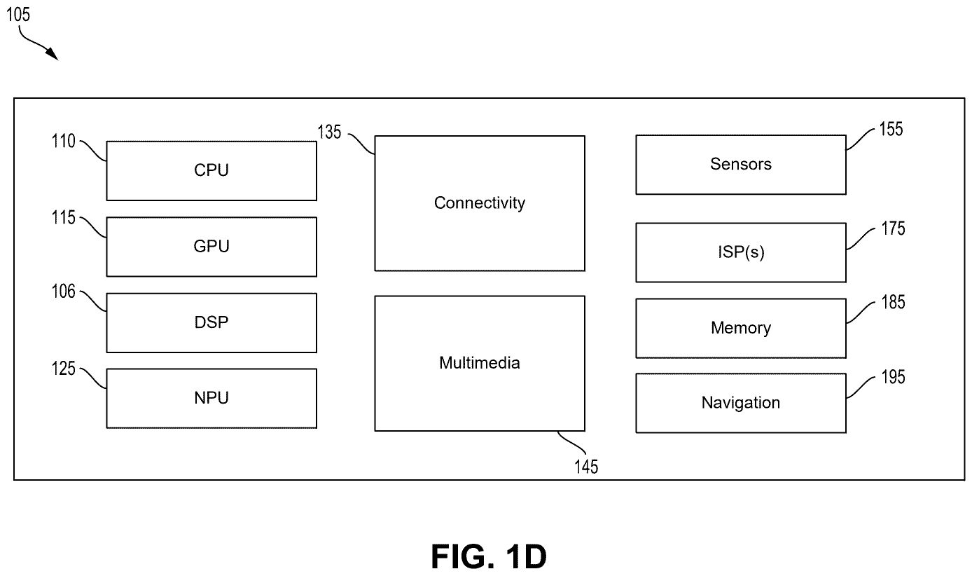

The systems and techniques described herein may be implemented by any type of system or device. One illustrative example of a system that can be used to implement the systems and techniques described herein is a vehicle (e.g., an autonomous or semi-autonomous vehicle) or a system or component (e.g., an ADAS or other system or component) of the vehicle. FIGS. 1A and 1B are diagrams illustrating an example vehicle 100 that may implement the systems and techniques described herein. With reference to FIGS. 1A and 1B, a vehicle 100 may include a control unit 140 and a plurality of sensors 102-138, including satellite geopositioning system receivers (e.g., sensors) 108, occupancy sensors 112, 116, 118, 126, 128, tire pressure sensors 114, 120, cameras 122, 136, microphones 124, 134, impact sensors 130, radar 132, and LIDAR 138. The plurality of sensors 102-138, disposed in or on the vehicle, may be used for various purposes, such as autonomous and semi-autonomous navigation and control, crash avoidance, position determination, etc., as well to provide sensor data regarding objects and people in or on the vehicle 100. The sensors 102-138 may include one or more of a wide variety of sensors capable of detecting a variety of information useful for navigation and collision avoidance. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, LIDAR 138, IR sensors, and ultrasonic sensors. The sensors may further include tire pressure sensors 114, 120, humidity sensors, temperature sensors, satellite geopositioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, proximity sensors, and other sensors.

The vehicle control unit 140 may be configured with processor-executable instructions to perform various embodiments using information received from various sensors, particularly the cameras 122, 136, radar 132, and LIDAR 138. In some embodiments, the control unit 140 may supplement the processing of camera images using distance and relative position information (e.g., relative bearing angle) that may be obtained from radar 132 and/or LIDAR 138 sensors. The control unit 140 may further be configured to control steering, breaking and speed of the vehicle 100 when operating in an autonomous or semi-autonomous mode using information regarding other vehicles determined using various embodiments.

FIG. 1C is a component block diagram illustrating a system 150 of components and support systems suitable for implementing various embodiments. With reference to FIGS. 1A, 1B, and 1C, a vehicle 100 may include a control unit 140, which may include various circuits and devices used to control the operation of the vehicle 100. In the example illustrated in FIG. 1C, the control unit 140 includes a processor 164, memory 166, an input module 168, an output module 170 and a radio module 172. The control unit 140 may be coupled to and configured to control drive control components 154, navigation components 156, and one or more sensors 158 of the vehicle 100.

The control unit 140 may include a processor 164 that may be configured with processor-executable instructions to control maneuvering, navigation, and/or other operations of the vehicle 100, including operations of various embodiments. The processor 164 may be coupled to the memory 166. The control unit 140 may include the input module 168, the output module 170, and the radio module 172.

The radio module 172 may be configured for wireless communication. The radio module 172 may exchange signals 182 (e.g., command signals for controlling maneuvering, signals from navigation facilities, etc.) with a network node 180, and may provide the signals 182 to the processor 164 and/or the navigation components 156. In some embodiments, the radio module 172 may enable the vehicle 100 to communicate with a wireless communication device 190 through a wireless communication link 92. The wireless communication link 92 may be a bidirectional or unidirectional communication link and may use one or more communication protocols.

The input module 168 may receive sensor data from one or more vehicle sensors 158 as well as electronic signals from other components, including the drive control components 154 and the navigation components 156. The output module 170 may be used to communicate with or activate various components of the vehicle 100, including the drive control components 154, the navigation components 156, and the sensor(s) 158.

The control unit 140 may be coupled to the drive control components 154 to control physical elements of the vehicle 100 related to maneuvering and navigation of the vehicle, such as the engine, motors, throttles, steering elements, other control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 140 may be coupled to the navigation components 156 and may receive data from the navigation components 156. The control unit 140 may be configured to use such data to determine the present position and orientation of the vehicle 100, as well as an appropriate course toward a destination. In various embodiments, the navigation components 156 may include or be coupled to a global navigation satellite system (GNSS) receiver system (e.g., one or more Global Positioning System (GPS) receivers) enabling the vehicle 100 to determine its current position using GNSS signals. Alternatively, or in addition, the navigation components 156 may include radio navigation receivers for receiving navigation beacons or other signals from radio nodes, such as Wi-Fi access points, cellular network sites, radio station, remote computing devices, other vehicles, etc. Through control of the drive control components 154, the processor 164 may control the vehicle 100 to navigate and maneuver. The processor 164 and/or the navigation components 156 may be configured to communicate with a server 184 on a network 186 (e.g., the Internet) using wireless signals 182 exchanged over a cellular data network via network node 180 to receive commands to control maneuvering, receive data useful in navigation, provide real-time position reports, and assess other data.

The control unit 140 may be coupled to one or more sensors 158. The sensor(s) 158 may include the sensors 102-138 as described, and may the configured to provide a variety of data to the processor 164.

While the control unit 140 is described as including separate components, in some embodiments some or all of the components (e.g., the processor 164, the memory 166, the input module 168, the output module 170, and the radio module 172) may be integrated in a single device or module, such as a system-on-chip (SOC) processing device. Such an SOC processing device may be configured for use in vehicles and be configured, such as with processor-executable instructions executing in the processor 164, to perform operations of various embodiments when installed into a vehicle.

FIG. 1D illustrates an example implementation of a system-on-a-chip (SOC) 105, which may include a central processing unit (CPU) 110 or a multi-core CPU, configured to perform one or more of the functions described herein. In some cases, the SOC 105 may be based on an ARM instruction set. In some cases, CPU 110 may be similar to processor 164. Parameters or variables (e.g., neural signals and synaptic weights), system parameters associated with a computational device (e.g., neural network with weights), delays, frequency bin information, task information, among other information may be stored in a memory block associated with a neural processing unit (NPU) 125, in a memory block associated with a CPU 110, in a memory block associated with a graphics processing unit (GPU) 115, in a memory block associated with a digital signal processor (DSP) 106, in a memory block 185, and/or may be distributed across multiple blocks. Instructions executed at the CPU 110 may be loaded from a program memory associated with the CPU 110 or may be loaded from a memory block 185.

The SOC 105 may also include additional processing blocks tailored to specific functions, such as a GPU 115, a DSP 106, a connectivity block 135, which may include fifth generation (5G) connectivity, fourth generation long term evolution (4G LTE) connectivity, Wi-Fi connectivity, USB connectivity, Bluetooth connectivity, and the like, and a multimedia processor 145 that may, for example, detect and recognize gestures. In one implementation, the NPU is implemented in the CPU 110, DSP 106, and/or GPU 115. The SOC 105 may also include a sensor processor 155, image signal processors (ISPs) 175, and/or navigation module 195, which may include a global positioning system. In some cases, the navigation module 195 may be similar to navigation components 156 and sensor processor 155 may accept input from, for example, one or more sensors 158. In some cases, the connectivity block 135 may be similar to the radio module 172.

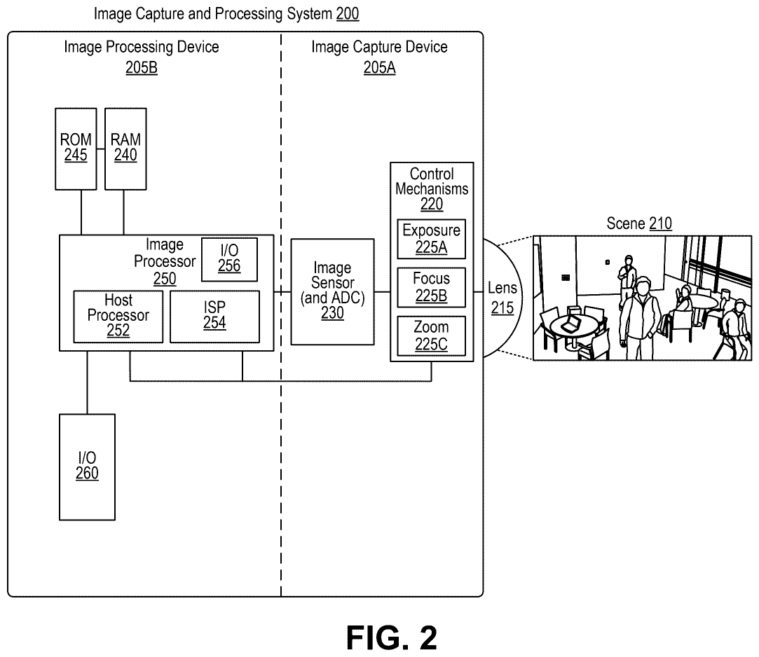

FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. A lens 215 of the system 200 faces a scene 210 and receives light from the scene 210. The lens 215 bends the light toward the image sensor 230. The light received by the lens 215 passes through an aperture controlled by one or more control mechanisms 220 and is received by an image sensor 230.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo, thereby adjusting focus. In some cases, additional lenses may be included in the system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), or some combination thereof. The focus setting may be determined using the control mechanism 220, the image sensor 230, and/or the image processor 250. The focus setting may be referred to as an image capture setting and/or an image processing setting.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 225C moves one or more of the lenses in the afocal zoom system, such as the negative lens and one or both of the positive lenses.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 230 may alternately or additionally include opaque and/or reflective masks that block light from reaching certain photodiodes, or portions of certain photodiodes, at certain times and/or from certain angles, which may be used for phase detection autofocus (PDAF). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 250 may include one or more processors, such as one or more image signal processors (ISPs) (including ISP 254), one or more host processors (including host processor 252), and/or one or more of any other type of processor 1810 discussed with respect to the computing system 1800. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 240/1825, read-only memory (ROM) 245/1820, a cache 1812, a memory unit (e.g., system memory 1815), another storage device 1830, or some combination thereof.

Various input/output (I/O) devices 260 may be connected to the image processor 250. The I/O devices 260 can include a display screen, a keyboard, a keypad, a touchscreen, a trackpad, a touch-sensitive surface, a printer, any other output devices 1835, any other input devices 1845, or some combination thereof. In some cases, a caption may be input into the image processing device 205B through a physical keyboard or keypad of the I/O devices 260, or through a virtual keyboard or keypad of a touchscreen of the I/O devices 260. The I/O 260 may include one or more ports, jacks, or other connectors that enable a wired connection between the system 200 and one or more peripheral devices, over which the system 200 may receive data from the one or more peripheral device and/or transmit data to the one or more peripheral devices. The I/O 260 may include one or more wireless transceivers that enable a wireless connection between the system 200 and one or more peripheral devices, over which the system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

The host processor 252 can configure the image sensor 230 with new parameter settings (e.g., via an external control interface such as I2C, I3C, SPI, GPIO, and/or other interface). In one illustrative example, the host processor 252 can update exposure settings used by the image sensor 230 based on internal processing results of an exposure control algorithm from past image frames. The host processor 252 can also dynamically configure the parameter settings of the internal pipelines or modules of the ISP 254 to match the settings of one or more input image frames from the image sensor 230 so that the image data is correctly processed by the ISP 254. Processing (or pipeline) blocks or modules of the ISP 254 can include modules for lens (or sensor) noise correction, de-mosaicing, color conversion, correction or enhancement/suppression of image attributes, denoising filters, sharpening filters, among others. Each module of the ISP 254 may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image sensor 230 can support dynamic switching between different operational modes that the image sensor 230 supports. Examples of the different operation modes include power off mode, software standby mode, stream on and off mode, among others. For instance, in stream operation mode, the image sensor is fully powered. With the stream operation on, the image sensor starts streaming image data (e.g., on the CSI-2 PHY layer port or interface). With the stream operation off, the image sensor stops streaming image data. In some cases, the host processor 252 can perform a dynamic parameter reconfiguration process that allows the image sensor 230 to support dynamic switching between the different operational modes without going through stream on and off and/or software standby procedures. Dynamic parameter reconfiguration refers to a process performed by the host processor 252 (e.g., an AP or other processor) to configure and update sensor internal register settings on-the-fly (e.g., as the operational modes change) without powering off the image sensor 230 and then powering on or putting the image sensor 230 into a software standby mode. Software standby mode refers to an operational mode of the image sensor 230 where the image sensor 230 is powered on and the camera control interface (CCI) communication is operational, but the image sensor 230 cannot capture and stream image data (e.g., on the CSI bus).

Such dynamic switching can reduce latency of mode switching processing and can improve user experience. Examples of the image sensor 230 dynamically switching between different operational modes include switching between turning high dynamic range (HDR) on and off, switching between a different number of exposures, switching between turning binning on and off (e.g., generating a 12 megapixel (MP) image using a 2×2 Quad Color Filter Array (QCFA) when binning is on and generating a 48 MP image by remosaicing the QCFA to a Bayer color filter array (CFA) when binning is off), among others.

Switching between operational modes (referred to as mode-switching scenarios) is different than changing image capture settings (referred to as non-mode-switching scenarios). For example, modifying image capture settings (e.g., exposure, focus, etc.) can result in a modification of how an image is captured and/or processed by the image sensor 230 and/or the ISP 254 (e.g., resulting in a brighter image, an image with a particular object in focus, etc.). However, if a setting of the image sensor 230 is incorrect or the image sensor 230 and/or ISP 254 are late in applying a setting in a non-mode-switching scenario, the result will be that a captured image is captured and/or processed with slight loss of quality in the processed image (e.g., without the intended settings, such as the image being slightly darker than intended, with an object slightly more out of focus than intended, etc.). However, when switching between operational modes in a mode-switching scenario (e.g., from HDR off to HDR on), applying the incorrect settings can result in a system failure, such as system hang or freeze, which can require a hardware reset of the ISP 254 and/or other components of the image capture and processing system 200. For instance, if the ISP 254 is unaware of the correct settings of an image frame produced by the image sensor 230 and mistakenly applies erroneous settings or parameters on that image frame for internal pipeline processing, the ISP 254 may freeze and require a hardware reset. As a result, instead of outputting an image frame with reduced quality, the image capture and processing system 200 may have to temporarily shut down and restart (e.g., the display screen may show a blank screen while the system 200 resets).

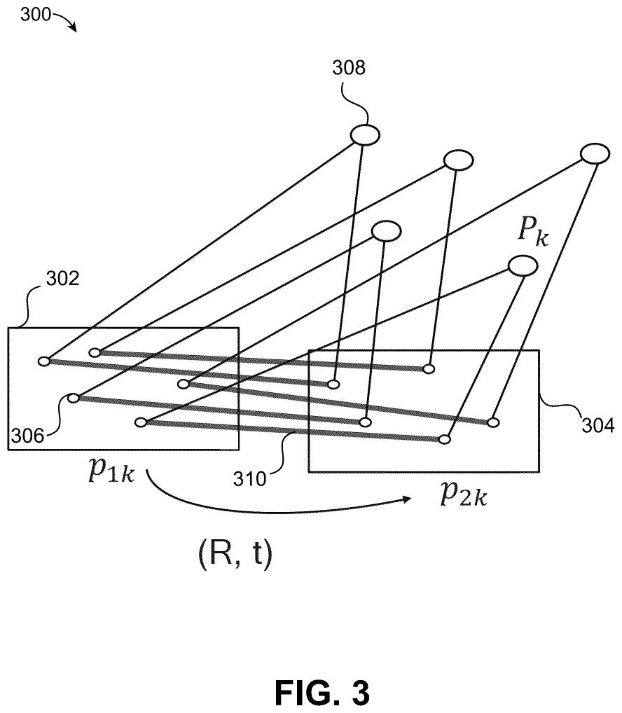

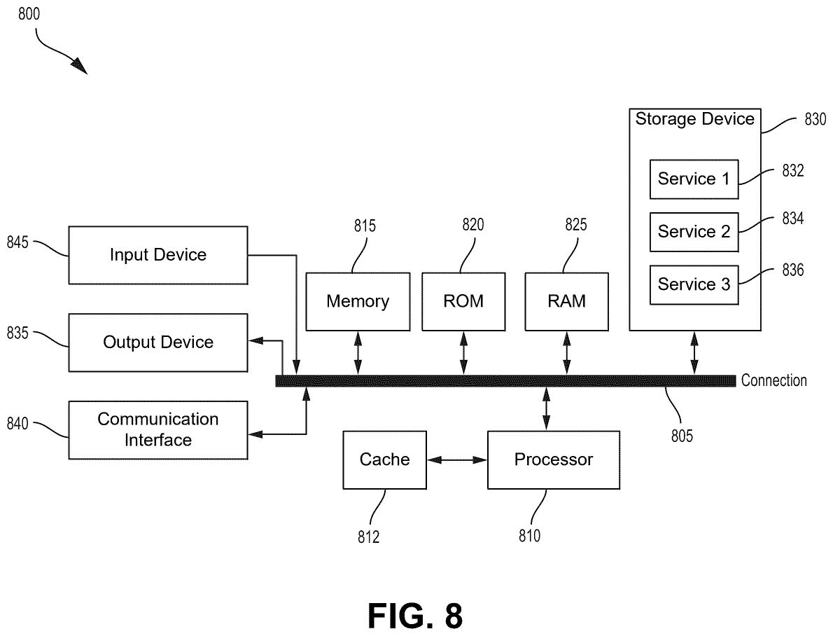

The systems described in the descriptions of FIG. 1A-1D (e.g., vehicle 100, system 150, SOC 105), FIG. 2 (e.g., image capture and processing system 200), and FIG. 8 can be used to perform visual odometry techniques to determine and update intrinsic parameters of an optical sensor. Further description of the visual odometry techniques is further described in the descriptions FIGS. 3-7.

FIG. 3 is a block diagram illustrating an example 300 of visual odometry (VO) performed across two images. Example 300 includes a first image 302 and a second image 304 generated, or captured, by an optical sensor such as a camera. In some examples, the first image 302 and the second image 304 are received from by a device (e.g., a mobile phone or other device) from the optical sensor. The first image 302 and the second image 304 include two-dimensional points 306 {p₁ₖ}, {p₂ₖ}. The two-dimensional points are two-dimensional representations of three-dimensional points 308 {Pₖ}. The three-dimensional points 308 {Pₖ} represent visual features (e.g., objects, colors, light) in an environment that are captured by the optical sensor.

Motion 310 represents movement of the optical sensor. The motion 310 can include translational movement of the camera represented by the two-dimensional points 306 from a first coordinate location associated with the first image 302 to a second coordinate location associated with the second image 304. In further examples, the motion 310 can include rotational movement of the optical sensor. For example, the rotational movement can be a change in orientation of the optical sensor from when the camera captured the first image 302 and when the camera captured the second image 304. The motion 310 can be represented as a rotational matrix “R” and a translational matrix “t”. In other cases, the motion 310 can be represented as a vector.

By way of a non-limiting example, the rotational matrix “R” can be a 3×3 matrix and the translational vector “t” can be 3×1 matrix. Elements of the 3×3 matrix can represent rotation of the optical sensor along an x-axis, y-axis, and z-axis. The translational vector can be a homogenous vector representing translation (e.g., movement) of corresponding points using an x-y axis. In further examples, the translational vector is not a homogeneous vector. For example, the translational vector can represent translation of corresponding points using an x-axis, y-axis, and z-axis (e.g., tx, ty, tz). R and t can be collectively referred to as the relative pose of the optical sensor.

In some examples, the two-dimensional points are 2×1 vectors, such as

$$p = [ \begin{matrix}x \\ y\end{matrix} ] .$$

In further examples, the two-dimensional points can be 3×1 homogeneous vectors, such as p=

$$[ \begin{matrix}x \\ y \\ 1\end{matrix} ] .$$

When assuming minimal to no lens distortion, the relationship between the three-dimensional points 308 and the two-dimensional points 306 can be defined as p˜K(RP+t) where p is the 3×1 homogenous vector associated with the two-dimensional points 306, P is a 3×1 vector associated with the three-dimensional points 308, and K is a 3×3 matrix representing the intrinsic parameters of the optical sensor.

For example, the intrinsic parameters of the optical sensor can be represented as the 3×3 matrix:

$$K = ( \begin{matrix}f & s & {c}_{x} \\ 0 & af & {c}_{y} \\ 0 & 0 & 1\end{matrix} )$$

where f, s, cₓ, c_{y}, and a represent intrinsic parameters of the optical sensor. By way of non-limiting example, optical sensor can include intrinsic parameters such as skew(s), focal length (f), aspect ratio (a), af (product of focal length and aspect ratio), and principal point (cₓ, c_{y}) of the optical sensor. Additional elements of the matrix (e.g., 0s and 1s) can represent padding to the 3×3 matrix of intrinsic parameters to facilitate matrix algebra operations.

An epipolar constraint can be determined based on the relation between corresponding two-dimensional points 306. Epipolar constraints can represent a geometric relationship between corresponding two-dimensional (2D) points of the first image and the second image. Corresponding two dimensional points of the first image and the second image can be along epipolar lines representing the motion of the sensor that captured the first image and the second image. For example, epipolar constraint can be represented as p₁, p₂ where p₁˜P (e.g., the three-dimensional point) and p₂˜K(RP+t). The three-dimensional points 308 can be mathematically eliminated from the equations of p₁, p₂ so that the epipolar constraint can be defined as a direct relation between the two-dimensional points 306. In order to determine the relative pose of the optical sensor (e.g., solving for R and t), the points p₁ and p₂ (and consequently the epipolar constraint defined as p₁, p₂) can be normalized, represented by equations \hat{p}₁=K⁻¹p₁ and \hat{p}₂=K⁻¹p₂. The normalized epipolar constraint can be represented as

$${\hat{p}}_{1}^{T} ( t \times ( R {\hat{p}}_{2} ) ) = 0 ,$$

where × denotes the cross product between two 3×1 vectors.

In another example, the epipolar constraint can be represented as \hat{p}₁^{T}E\hat{p}₂=0 where \hat{p}₁ and \hat{p}₂ are normalized two-dimensional points, E is an essential matrix (3×3 matrix) represented as a function of R and t assuming the intrinsic parameters of the optical sensor are known.

R and t can be estimated based on the epipolar constraints. For example, R and t can be estimated by determining epipolar constraints associated with multiple corresponding two-dimensional point pairs, represented as p₁ₖ, p₂ₖ. In some examples, R and t can be estimated analytically or iteratively.

In some examples of VO, intrinsic parameters of the optical sensor are assumed known, such as when the intrinsic parameters of the optical sensor are assumed based on tolerances and capabilities of the hardware comprising the optical (e.g., capabilities from a manufacturer specification sheet). Intrinsic parameters of the optical sensor can change gradually over time as hardware associated with the optical sensor degrades. In further examples, changes in temperature can cause intrinsic parameters to change. When accounting for changes in intrinsic parameters, the equation p˜K(RP+t) is modified by adding a non-linear function, such as a non-linear lens distortion function, to become p˜Kh(RP+t) where h is the non-linear function (e.g., the non-linear lens distortion function).

Points p₁, p₂ associated with the two-dimensional points 306 also are modified when accounting for changes in intrinsic parameters. The normalized points \hat{p}₁ and \hat{p}₂ can be represented as \hat{p}₁=h⁻¹(K⁻¹p₁) and \hat{p}₂=h⁻¹(K⁻¹\hat{p}₂). The epipolar constraint can be represented as

$${\hat{p}}_{1}^{T} ( t \times ( R {\hat{p}}_{2} ) ) = 0 .$$

When the intrinsic parameters are unknown (e.g., when determining changes to the intrinsic parameters), \hat{p}₁ and \hat{p}₂ are functions of the intrinsic parameters (e.g., functions of K). Additionally, because \hat{p}₁ and \hat{p}₂ are functions of K, \hat{p}₁ and \hat{p}₂ are multi-variable equations based on K, R, and t.

Various analytical techniques can be used to estimate the intrinsic parameters and the relative pose (e.g., R and t) of the optical sensor. For example, a device (e.g., SOC 105 of FIG. 1D) can perform non-linear optimization techniques to minimize a goal function associated with the intrinsic parameters. For example, the goal function can be

$$e = {\sum }_{k} {( {\hat{p}}_{1 k}^{T} ( t \times ( R {\hat{p}}_{2 k} ) ) )}^{2} .$$

In some examples, the goal function can be solving a least squares problem with respect to R, t, K. In another example, the goal function can be minimized using a Levenberg-Marquardt or DogLeg algorithm.

In some examples, the goal function can be further adjusted to include a robust weight (e.g., taken from Huber or Cauchy M-Estimators). In further examples, the relative pose and intrinsic parameters can be estimated using random sample consensus (RANSAC) or various iterative robust methods (e.g., least trimmed squares, iteratively reweighted least squares, etc.).

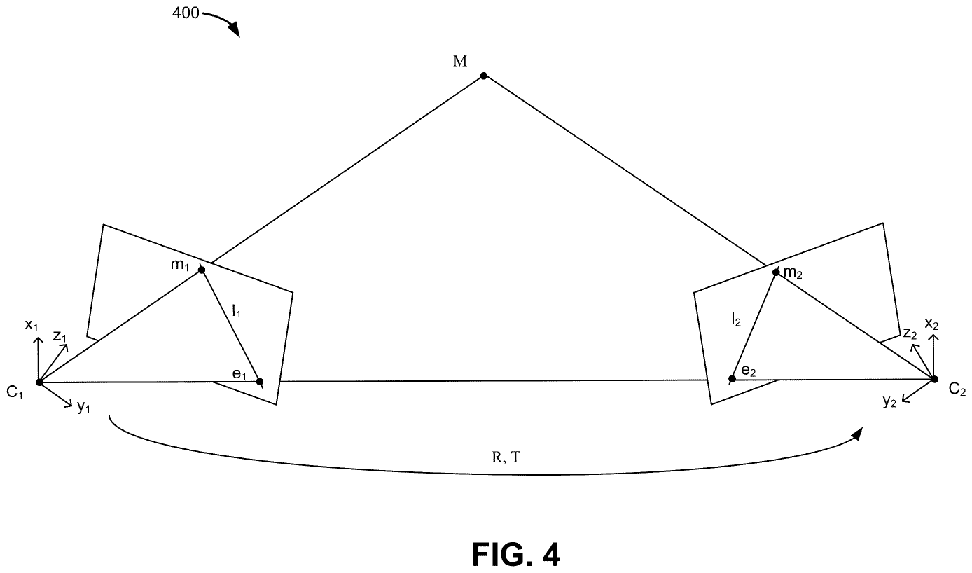

FIG. 4 is a block diagram illustrating an example of relative pose determination using keypoints (e.g., corresponding points) from images captured by a camera (and in some cases received by a device) at a first time and first location C1 and images captured by (and in some cases received from) the camera at a second time and second location C2 according to various aspects of the present disclosure. In the example shown in FIG. 4, the camera can be positioned on various devices, such as an extended reality (XR) device, a mobile device, a vehicle, or a roadside unit. A real point M in three-dimensional space (x, y, z) may be projected onto the respective image planes I1 and I2 of the camera to produce features (keypoints) m1 and m2. By correlating or associating (e.g., matching) multiple sets of features (e.g., corresponding to multiple real points), the epipolar constraint (e.g., line l1 between m1 and e1 and line l2 between m2 and e2) on the relative vehicle pose can be determined. As a result, based on the keypoints of multiple real points and the epipolar constraint, a device associated with the camera can determine the changes in the relative pose (Rotation (R), Translation (T)) of the camera from C1 to C2. If the location of the camera at C1 or C2 (in a global coordinate system) is known, the device can determine the relative pose of the camera at the other time and location (e.g., if the location of the camera at C1 is known, the location of the camera at C2 can be determined).

The same principles apply to determining a change in a pose of a single camera between a first time and a second time. For example, at a first time the camera can be at the position of C1 and can capture I1. At a second time, the camera can be at the position of C2 and can capture I2. A device including the camera can determine the change in pose between the first time and the second time as described above.

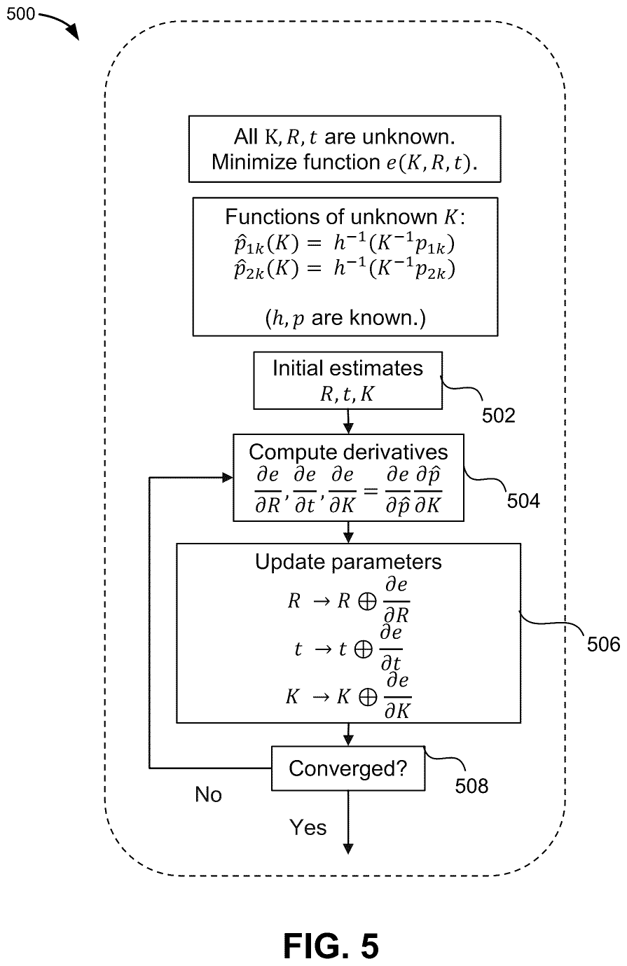

FIG. 5 is a flow diagram illustrating an example of a process 500 for determining intrinsic parameters of an optical sensor using visual odometry. The process can be performed by a computing device (e.g., image capture and processing system 200 of FIG. 2, the image processor, a computing device or computing system 800 of FIG. 8, and/or other device or system) or by a component or system (e.g., a chipset, one or more processors, one or more central processing units (CPUs), digital signal processors (DSPs), graphics processing units (GPUs), any combination thereof, and/or other type of processor(s), or other component or system) of the computing device. The operations of the process 500 may be implemented as software components that are executed and run on one or more processors (e.g., processor 810 of FIG. 8 or other processor(s)). Further, the transmission and reception of signals by the computing device in the process 500 can be enabled, for example, by one or more antennas and/or one or more transceivers (e.g., wireless transceiver(s)). The operations of the process 500 assume intrinsic parameters (K) and relative pose (R and t) of the optical sensor are not known. The operations of the process 500 further assumes a non-linear lens distortion function (h) and corresponding two-dimensional points from two or more images captured by the optical sensor (p₁, p₂) are known.

At block 502, the computing device (or component thereof) can include generating initial estimates of a relative pose and intrinsic parameters of an optical sensor (e.g., estimating R, t, and K as further described in the description of FIG. 3). The computing device (or component thereof) can generate the initial estimates by solving (e.g., iteratively solving) a non-linear least squares equation (e.g., a goal function). In some examples, an initial iteration of estimating a solution of the non-linear least squares can be the initial estimates of the relative pose and intrinsic parameters.

At block 504, the computing device (or component thereof) can compute derivatives of the intrinsic parameters and the relative pose. The derivatives can be based on both ∂e/∂\hat{p} and ∂\hat{p}/∂K using chain rule derivations (e.g., derivatives with respect to the intrinsic parameters and normalized points \hat{p}₁ and \hat{p}₂). In further examples, the computing device can use 2^{nd} order derivatives or approximations of 2^{nd} order derivatives of the intrinsic parameters and the relative pose. In such an example, the computing device can use a Gauss-Newton algorithm to estimate the intrinsic parameters.

At block 506, the computing device (or component thereof) can update parameters of the goal function (e.g., R, t, and K). The symbol ⊕ can denote incremental changes to of the parameters of the of the goal function. For example, the incremental change can include updating parameters of the goal function (e.g., x+dx). In further examples, the incremental change can include a rotation of one or more parameters such as by adding Euler angles to the one or more parameters. In some examples, the ⊕ can denote a linear or nonlinear update method, such as a gradient search, Levenberg-Marquardt, or DogLeg. For example, process 500 can be an iterative process with each iteration calculating estimations of R, t, and K to minimize the goal function. In some examples, the incremental changes of the goal function can have variable step lengths (e.g., amount of change to the parameters). For example, linear or nonlinear update methods can have different step lengths (e.g., DogLeg can have a different step length from Levenberg-Marquardt, etc.)

At block 508, the computing device (or component thereof) can determine whether the updated parameters of block 506 converge to a solution for R, t, and K. For example, the computing device (or component thereof) can determine the parameters of block 506, which includes the intrinsic parameters (K), converges when subsequent iterations of calculating the parameters do not exceed a predetermined error tolerance. For example, the error tolerance can represent a predetermined acceptable amount of deviation in a previous calculation of the intrinsic parameters (K) to a subsequent calculation of the intrinsic parameters (K). When the deviation between the previous calculations of R, t, and K (or just K) is less than the predetermined error tolerance, the computing device (or component thereof) can determine the updated parameters of block 506 converge. In some examples, the computing device can update parameters of block 506 for a preset number of iterations to estimate parameters.

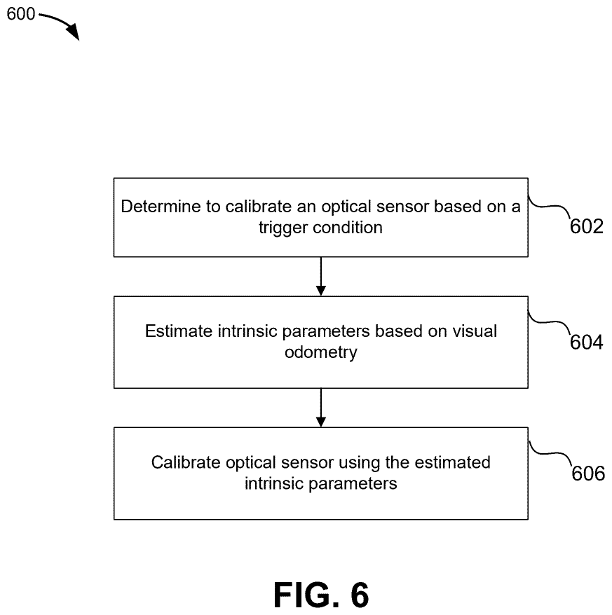

FIG. 6 is a flow diagram illustrating an example of a process 600 for calibrating an optical sensor. The process can be performed by a computing device (e.g., image capture and processing system 200 of FIG. 2, the image processor, a computing device or computing system 800 of FIG. 8, and/or other device or system) or by a component or system (e.g., a chipset, one or more processors, one or more central processing units (CPUs), digital signal processors (DSPs), graphics processing units (GPUs), any combination thereof, and/or other type of processor(s), or other component or system) of the computing device. The operations of the process 600 may be implemented as software components that are executed and run on one or more processors (e.g., processor 810 of FIG. 8 or other processor(s)). Further, the transmission and reception of signals by the computing device in the process 600 may be enabled, for example, by one or more antennas and/or one or more transceivers (e.g., wireless transceiver(s)).

At block 602, the computing device (or component thereof) can determine to calibrate an optical sensor based on a trigger condition. Intrinsic parameters of optical sensors can change based on the operating conditions of the optical sensors. For example, an optical sensor operating at 102 degrees Fahrenheit can have different intrinsic parameters than an optical sensor of the same make and model operating at 30 degrees Fahrenheit. The trigger condition can represent conditions of an environment in which the optical sensor is operating which can cause the intrinsic parameters of the optical sensor to change. As previously mentioned, temperature can cause intrinsic parameters of the optical sensor to change. Further examples can include sun exposure, such as receiving continued exposure to UV rays. In further examples, the trigger condition can be based on time. For example, the trigger condition can be that a predetermined period of time elapsed since the optical sensor was calibrated to account for changes in intrinsic parameters of the optical sensor. In one such example, the computing device (or component thereof) can determine to calibrate the optical sensor on a schedule, such as once a month.

In some examples, the computing device (or component thereof) can receive a request to calibrate the optical sensor. For example, a manufacturer or maintainer of the optical sensor can transmit a request to calibrate the sensor. The computing device (or component thereof) can perform process 600 based on the request.

At block 604, the computing device (or component thereof) can estimate intrinsic parameters based on visual odometry. The computing device can perform the various estimation techniques described in the descriptions of FIG. 3, FIG. 4, and FIG. 5 to estimate the intrinsic parameters.

At block 606, the computing device (or component thereof) can calibrate the optical sensor using the estimated intrinsic parameters. In some examples, calibrating the optical sensor can include updating memory associated with intrinsic parameters to the estimated intrinsic parameters. For example, the optical sensor can include memory to store intrinsic parameters of the optical sensor, such as skew, focal length, and principal point. When the computing device (or component thereof) determines that there is a deviation in the estimated intrinsic parameters and stored intrinsic parameters, the computing device (or component thereof) can update the stored intrinsic parameters to the estimated intrinsic parameters to calibrate the optical sensor.

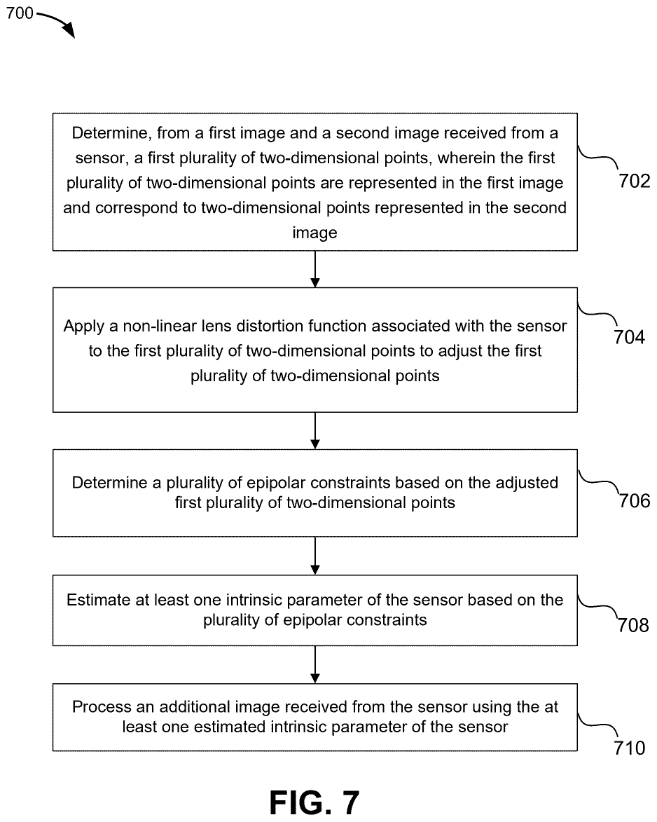

FIG. 7 is a flow diagram illustrating an example of a process 700 for calibrating a sensor. The process 700 can be performed by a computing device (e.g., image capture and processing system 200 of FIG. 2, a computing device or computing system 800 of FIG. 8, and/or other device or system) or by a component or system (e.g., a chipset, one or more processors, one or more central processing units (CPUs), digital signal processors (DSPs), graphics processing units (GPUs), any combination thereof, and/or other type of processor(s), or other component or system) of the computing device. The operations of the process 700 may be implemented as software components that are executed and run on one or more processors (e.g., processor 810 of FIG. 8 or other processor(s)). Further, the transmission and reception of signals by the computing device in the process 700 may be enabled, for example, by one or more antennas and/or one or more transceivers (e.g., wireless transceiver(s)).

At block 702, the computing device (or component thereof) can determine, from a first image and a second image received from a sensor, a first plurality of two-dimensional points. The first plurality of two-dimensional points are represented in the first image and correspond to two-dimensional points represented in the second image. For example, the sensor can be an optical sensor such as an image sensor (e.g., a camera) or other type of sensor. The computing device (or component thereof) can use various visual odometry (VO) techniques to determine the two-dimensional points. For example, the computing device can use the visual odometry techniques described in the description of FIG. 3 and FIG. 4.

At block 704, the computing device (or component thereof) can apply a non-linear lens distortion function associated with the sensor to the first plurality of two-dimensional points to adjust the first plurality of two-dimensional points. In some examples, adjusting the first plurality of two-dimensional points can include normalizing the first plurality of two-dimensional points. In further examples, the non-linear lens distortion function can represent deviations in the way light passes through the lens (e.g., reflections, refractions, etc.). The computing device (or component thereof) can apply the non-linear lens distortion function by providing the first plurality of two-dimensional points as inputs to the non-linear lens distortion function.

At block 706, the computing device (or component thereof) can determine a plurality of epipolar constraints based on the adjusted first plurality of two-dimensional points. Epipolar constraints can represent a geometric relationship between corresponding two-dimensional (2D) points of the first image and the second image. Corresponding two dimensional points of the first image and the second image can be along epipolar lines representing the motion of the sensor that captured the first image and the second image. In some examples, the computing device can determine multiple epipolar constraints associated with visual elements of the first image and the second image (e.g., a multipolar constraint associated with a respective pair of corresponding 2D points of the first image and the second image).

At block 708, the computing device (or component thereof) can estimate at least one intrinsic parameter of the sensor based on the plurality of epipolar constraints. Intrinsic parameters of a sensor can be a representation of how the sensor interprets and transforms physical measurements into digital data. For example, intrinsic parameters of an optical sensor can include focal length (e.g., field of view and depth of focus), principal point (e.g., optical center), skew, and aspect ratio. In some examples, the intrinsic parameters of the optical sensor can be represented as a matrix of values associated with the focal length, principal point, skew, and the aspect ratio.

At block 710, the computing device (or component thereof) can process an additional image received from the sensor using the at least one estimated intrinsic parameter of the sensor. For example, the computing device can update a register of values in memory representing intrinsic parameters. For example, a lens of the sensor can decay due to age and exposure to sunlight. The computing device can adjust values representing intrinsic parameters of the sensor. For example, warping of a lens can cause a change in the focal length of the sensor. The computing device can compensate for the change in the focal length of the sensor by updating a value associated with the focal length of the sensor.

In some examples, the computing device (or component thereof) can time filter the intrinsic parameters. For example, the computing device (or component thereof) can apply a filter, such as an average filter, a Kalman filter, or a histogram based filter, to the intrinsic parameters to remove noise. In further examples, plurality of epipolar constraints can include epipolar constraints associated with additional images with different motion (e.g., a different R and t) but the same intrinsic parameters (e.g., the additional images captured by the same optical sensor).

In some aspects, the computing device (or component thereof) can determine, from a third image and a fourth image received from the sensor, a second plurality of two-dimensional points. The second plurality of points are represented in the third image and correspond to two-dimensional points represented in the fourth image. The computing device (or component thereof) can apply the non-linear lens distortion function associated with the sensor to the second plurality of two-dimensional points to adjust the second plurality of two-dimensional points. In some cases, the determination of the plurality of epipolar constraints is additionally based on the adjusted second plurality of two-dimensional points.

In some cases, the computing device (or component thereof) can receive temperature data associated with a temperature of the sensor. The computing device (or component thereof) can determine to update the at least one intrinsic parameter of the sensor based on the temperature. In some aspects, the computing device (or component thereof) can determine to update the at least one intrinsic parameter of the sensor based on a period of elapsed time from a previous update exceeding a predetermined threshold.

In some aspects, the computing device (or component thereof) can process the plurality of epipolar constraints to reduce a goal function associated with the at least one intrinsic parameter of the sensor. In such aspects, the at least one estimated intrinsic parameter can be based on the plurality of epipolar constraints and the reduced goal function. In some examples, the computing device (or component thereof) can process the plurality of epipolar constraints to reduce the goal function associated with the at least one intrinsic parameter of the sensor, where the goal function is additionally associated with a relative motion of the sensor. For instance, the relative motion of the sensor can be represented as a matrix or a vector associated with a change in orientation of the sensor and a translation vector associated with a change in location of the sensor. In some cases, the computing device (or component thereof) can estimate the relative motion of the sensor based on the reduced goal function.

FIG. 8 is a block diagram illustrating an example of a computing system 800, which may be employed for online intrinsic calibration. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800.

Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more range sensors (e.g., LiDAR sensors, laser range finders, RF radars, ultrasonic sensors, and infrared (IR) sensors) configured to collect data and provide measurements to processor 810, whereby processor 810 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding or incorporated in a combined video encoder-decoder (CODEC).

Illustrative aspects of the disclosure include:

Aspect 1: An apparatus for image processing, the apparatus comprising: at least one memory; and at least one processor coupled to the at least one memory and configured to: determine, from a first image and a second image received from a sensor, a first plurality of two-dimensional points, wherein the first plurality of two-dimensional points are represented in the first image and correspond to two-dimensional points represented in the second image; apply a non-linear lens distortion function associated with the sensor to the first plurality of two-dimensional points to adjust the first plurality of two-dimensional points; determine a plurality of epipolar constraints based on the adjusted first plurality of two-dimensional points; estimate at least one intrinsic parameter of the sensor based on the plurality of epipolar constraints; and process an additional image received from the sensor using the at least one estimated intrinsic parameter of the sensor.

Aspect 2: The apparatus of Aspect 1, wherein the at least one processor is configured to time filter the at least one intrinsic parameter of the sensor.

Aspect 3: The apparatus of Aspect 1, wherein the at least one processor is configured to time filter the at least one intrinsic parameter of the sensor using at least one of an average filter, a Kalman filter, or a histogram based filter.

Aspect 4: The apparatus of any of Aspects 2 to 3, wherein the at least one processor is configured to: determine, from a third image and a fourth image received from the sensor, a second plurality of two-dimensional points, wherein the second plurality of points are represented in the third image and correspond to two-dimensional points represented in the fourth image; and apply the non-linear lens distortion function associated with the sensor to the second plurality of two-dimensional points to adjust the second plurality of two-dimensional points; and wherein the determination of the plurality of epipolar constraints is additionally based on the adjusted second plurality of two-dimensional points.

Aspect 5: The apparatus of any of Aspects 2 to 4, wherein the sensor is an image sensor.

Aspect 6: The apparatus of Aspect 5, wherein the intrinsic parameter includes at least one of a focal length or a principal point of the image sensor.

Aspect 7: The apparatus of any of Aspects 2 to 6, wherein the at least one processor is configured to: receive temperature data associated with a temperature of the sensor; and determine to update the at least one intrinsic parameter of the sensor based on the temperature.

Aspect 8: The apparatus of any one of Aspects 2 to 7, wherein the at least one processor is configured to: determine to update the at least one intrinsic parameter of the sensor based on a period of elapsed time from a previous update exceeding a predetermined threshold.

Aspect 9: The apparatus of any of Aspects 2 to 8, wherein the at least one processor is configured to: process the plurality of epipolar constraints to reduce a goal function associated with the at least one intrinsic parameter of the sensor, wherein the at least one estimated intrinsic parameter is based on the plurality of epipolar constraints and the reduced goal function.

Aspect 10: The apparatus of Aspect 9, wherein the at least one processor is configured to: process the plurality of epipolar constraints to reduce the goal function associated with the at least one intrinsic parameter of the sensor, wherein the goal function is additionally associated with a relative motion of the sensor.

Aspect 11: The apparatus of Aspect 10, wherein the relative motion of the sensor is represented as a matrix or a vector associated with a change in orientation of the sensor and a translation vector associated with a change in location of the sensor.

Aspect 12: The apparatus of Aspect 11, wherein the at least one processor is configured to: estimate the relative motion of the sensor based on the reduced goal function.

Aspect 13: A method for image processing, the method comprising: determining, from a first image and a second image received from a sensor, a first plurality of two-dimensional points, wherein the first plurality of two-dimensional points are represented in the first image and correspond to two-dimensional points represented in the second image; applying a non-linear lens distortion function associated with the sensor to the first plurality of two-dimensional points to adjust the first plurality of two-dimensional points; determining a plurality of epipolar constraints based on the adjusted first plurality of two-dimensional points; estimating at least one intrinsic parameter of the sensor based on the plurality of epipolar constraints; and processing an additional image received from the sensor using the at least one estimated intrinsic parameter of the sensor.

Aspect 14: The method of Aspect 13, further comprising time filtering the at least one intrinsic parameter of the sensor.

Aspect 15: The method of Aspect 13, further comprising time filtering the at least one intrinsic parameter of the sensor using at least one of an average filter, a Kalman filter, or a histogram based filter.

Aspect 16: The method of any of Aspects 13 to 15, further comprising: determining, from a third image and a fourth image received from the sensor, a second plurality of two-dimensional points, wherein the second plurality of points are represented in the third image and correspond to two-dimensional points represented in the fourth image; and applying the non-linear lens distortion function associated with the sensor to the second plurality of two-dimensional points to adjust the second plurality of two-dimensional points; and wherein the determination of the plurality of epipolar constraints is additionally based on the adjusted second plurality of two-dimensional points.

Aspect 17: The method of any of Aspects 13 to 16, wherein the sensor is an image sensor.

Aspect 18: The method of any of Aspects 13 to 17, wherein the intrinsic parameter includes at least one of a focal length or a principal point of the image sensor.

Aspect 19: The method of any of Aspects 13 to 18, further comprising: receiving temperature data associated with a temperature of the sensor; and determining to update the at least one intrinsic parameter of the sensor based on the temperature.

Aspect 20: The method of any of Aspects 13 to 19, further comprising: determining to update the at least one intrinsic parameter of the sensor based on a period of elapsed time from a previous update exceeding a predetermined threshold.

Aspect 21: The method of any of Aspects 13 to 20, further comprising: processing the plurality of epipolar constraints to reduce a goal function associated with the intrinsic parameter of the sensor, wherein the estimated intrinsic parameter is based on the plurality of epipolar constraints and the reduced goal function.

Aspect 22: The method of Aspect 21, further comprising: processing the plurality of epipolar constraints to reduce the goal function associated with the at least one intrinsic parameter of the sensor, wherein the goal function is additionally associated with a relative motion of the sensor.

Aspect 23: The method of Aspect 22, wherein the relative motion of the sensor is represented as a matrix associated with a change in orientation of the sensor and a translation vector associated with a change in location of the sensor.

Aspect 24: The method of Aspect 23, further comprising: estimating the relative motion of the sensor based on the reduced goal function.

Aspect 25: An apparatus for image processing is provided. The apparatus includes one or more means for performing operations according to any of Aspects 13 to 24.

Aspect 26: A non-transitory computer-readable medium is provided having stored thereon instructions that, when executed by at least one processor, cause the at least one processor to perform operations according to any of Aspects 13 to 24.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
determine, from a first image and a second image received from a sensor, a first plurality of two-dimensional points, wherein the first plurality of two-dimensional points are represented in the first image and correspond to two-dimensional points represented in the second image;
apply a non-linear lens distortion function associated with the sensor to the first plurality of two-dimensional points to adjust the first plurality of two-dimensional points;
determine a plurality of epipolar constraints based on the adjusted first plurality of two-dimensional points;
estimate at least one intrinsic parameter of the sensor based on the plurality of epipolar constraints; and
process an additional image received from the sensor using the at least one estimated intrinsic parameter of the sensor.

2. The apparatus of claim 1, wherein the at least one processor is configured to time filter the at least one intrinsic parameter of the sensor.

3. The apparatus of claim 1, wherein the at least one processor is configured to time filter the at least one intrinsic parameter of the sensor using at least one of an average filter, a Kalman filter, or a histogram based filter.

4. The apparatus of claim 1, wherein the at least one processor is configured to:
determine, from a third image and a fourth image received from the sensor, a second plurality of two-dimensional points, wherein the second plurality of two-dimensional points are represented in the third image and correspond to two-dimensional points represented in the fourth image; and
apply the non-linear lens distortion function associated with the sensor to the second plurality of two-dimensional points to adjust the second plurality of two-dimensional points;
wherein the determination of the plurality of epipolar constraints is additionally based on the adjusted second plurality of two-dimensional points.

5. The apparatus of claim 1, wherein the sensor is an image sensor.

6. The apparatus of claim 5, wherein the at least one intrinsic parameter includes at least one of a focal length or a principal point of the image sensor.

7. The apparatus of claim 1, wherein the at least one processor is configured to:
receive temperature data associated with a temperature of the sensor; and
determine to update the at least one intrinsic parameter of the sensor based on the temperature.

8. The apparatus of claim 1, wherein the at least one processor is configured to:
determine to update the at least one intrinsic parameter of the sensor based on a period of elapsed time from a previous update exceeding a predetermined threshold.

9. The apparatus of claim 1, wherein the at least one processor is configured to:
process the plurality of epipolar constraints to reduce a goal function associated with the at least one intrinsic parameter of the sensor, wherein the at least one estimated intrinsic parameter is based on the plurality of epipolar constraints and the reduced goal function.

10. The apparatus of claim 9, wherein the at least one processor is configured to:
process the plurality of epipolar constraints to reduce the goal function associated with the at least one intrinsic parameter of the sensor, wherein the goal function is additionally associated with a relative motion of the sensor.

11. The apparatus of claim 10, wherein the relative motion of the sensor is represented as a matrix or a vector associated with a change in orientation of the sensor and a translation vector associated with a change in location of the sensor.

12. The apparatus of claim 11, wherein the at least one processor is configured to:
estimate the relative motion of the sensor based on the reduced goal function.

13. A method for image processing, the method comprising:
determining, from a first image and a second image received from a sensor, a first plurality of two-dimensional points, wherein the first plurality of two-dimensional points are represented in the first image and correspond to two-dimensional points represented in the second image;
applying a non-linear lens distortion function associated with the sensor to the first plurality of two-dimensional points to adjust the first plurality of two-dimensional points;
determining a plurality of epipolar constraints based on the adjusted first plurality of two-dimensional points;
estimating at least one intrinsic parameter of the sensor based on the plurality of epipolar constraints; and
processing an additional image received from the sensor using the at least one estimated intrinsic parameter of the sensor.

14. The method of claim 13, further comprising time filtering the at least one intrinsic parameter of the sensor.

15. The method of claim 13, further comprising time filtering the at least one intrinsic parameter of the sensor using at least one of an average filter, a Kalman filter, or a histogram based filter.

16. The method of claim 13, further comprising:
determining, from a third image and a fourth image received from the sensor, a second plurality of two-dimensional points, wherein the second plurality of points are represented in the third image and correspond to two-dimensional points represented in the fourth image; and
applying the non-linear lens distortion function associated with the sensor to the second plurality of two-dimensional points to adjust the second plurality of two-dimensional points;
wherein the determination of the plurality of epipolar constraints is additionally based on the adjusted second plurality of two-dimensional points.

17. The method of claim 13, wherein the sensor is an image sensor.

18. The method of claim 17, wherein the intrinsic parameter includes at least one of a focal length or a principal point of the image sensor.

19. The method of claim 13, further comprising:
receiving temperature data associated with a temperature of the sensor; and
determining to update the at least one intrinsic parameter of the sensor based on the temperature.

20. A non-transitory computer-readable medium having stored thereon instructions that, when executed by at least one processor, cause the at least one processor to:
determine, from a first image and a second image received from a sensor, a first plurality of two-dimensional points, wherein the first plurality of two-dimensional points are represented in the first image and correspond to two-dimensional points represented in the second image;
apply a non-linear lens distortion function associated with the sensor to the first plurality of two-dimensional points to adjust the first plurality of two-dimensional points;
determine a plurality of epipolar constraints based on the adjusted first plurality of two-dimensional points;
estimate at least one intrinsic parameter of the sensor based on the plurality of epipolar constraints; and
process an additional image received from the sensor using the at least one estimated intrinsic parameter of the sensor.
